(19) United States
(12) Patent Application Publication
(10) Pub. No.: US 2016/0092040 A1
(43) Pub. Date: Mar. 31, 2016

(54) COMMUNICATION DEVICE WITH CONTACT INFORMATION INFERENCE

(71) Applicant: EBAY INC., San Jose, CA (US)

(72) Inventor: Corinne Elizabeth Sherman, San Jose, CA (US)

(21) Appl. No.: 14/499,064

(22) Filed: Sep. 26, 2014

(51) Int. Cl. G06F 3/0482; G06F 3/0484; H04L 12/58

(52) U.S. Cl. CPC G06F 3/0482; H04L 51/32; G06F 3/04847; G06F 3/04842

(57) ABSTRACT

Communication devices and/or systems are provided for inferring additional information about the contact information maintained in a user's electronic address book. In particular, the additional information may include relationship information or context information inferred based on location and/or correspondence between the user and the others. In an embodiment, the system may identify and analyze communications, such as emails, text messages, or the like, between the user and other users to determine or infer context and relationship between the user and the other users. Communication history between the user and other users also may be used to provide context and relationship history between the user and other users listed in the user's contact list.

### BACKGROUND

1. Field of the Invention

The present invention generally relates to communication devices configured to implement contact information inference.

2. Related Art

Consumers increasingly are relying on electronic devices and digital media to keep track of their contact information. For example, a user may download a contact management application on a mobile device to store and manage contact information of the user's friends, colleagues, or the like. However, the contact management application typically stores basic information of other users, such as name, address, phone number, and the like, without providing context information. As such, it may be difficult for the user to determine the relationship or context between the user and other users based on the basic information of other users. Therefore, there is a need for communication devices that help manage a user's contact information and that further provides context and inference based on the contact information.

### BRIEF DESCRIPTION OF THE FIGURES

FIG. 1 is a block diagram of a networked system including communication devices suitable for implementing contact information inference according to an embodiment.

FIG. 2 is a flowchart showing a process of setting up a user account for contact information inference according to an embodiment.

FIG. 3 is a flowchart showing a process for contact information inference according to one embodiment.

FIG. 4 is a block diagram of a communication device suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, communication devices and/or systems are provided for inferring additional information about the contact information maintained in a user's electronic address book. In particular, the additional information may include relationship information or context information inferred based on location and/or correspondence between the user and the others.

In an embodiment, the system may identify and analyze communications, such as emails, text messages, or the like, between the user and other users to determine or infer context and relationship between the user and the other users. Communication history between the user and other users also may be used to provide context and relationship history between the user and other users listed in the user's contact list.

In an embodiment, the system may monitor and analyze the location and/or movement of the user in relation with the locations and/or movements of the other users to determine or infer context and relationship between the user and the other users. For example, if the user and another user are introduced to each other at a conference, the system may associate the location and/or event of the conference with the contact information of this other user to provide context and relationship history to the contact information.

In an embodiment, the system may monitor various interactions between the user and other users to provide relationship context between the user and the other users. For example, relationship context may be determined or inferred based on user interactions, such as meetings, outings, meals, conferences, group organization chart, social network, phone calls, video conferences, emails, text messages, project management, group affiliations, events attended together, projects or business deals worked on together, educational institute affiliations, relationship with other users, and the like. In an embodiment, the system may monitor and track the interactions between two users to construct a relationship history or an interaction history between two users to provide context to their business and/or personal relationship.

In an embodiment, an importance score may be calculated based on the relationship and/or interactions between two users to indicate the value or importance of the relationship. In an embodiment, an importance score may be calculated for personal relationship. Importance scores for personal relationship may be calculated based on interactions between two users, such as meals shared, events attended together, communication, frequency of interactions, number of interactions, social network account, family tree, number of shared friends, degree of relationship of shared friends, and the like. As the number or frequency of interactions increases, the importance score also may increase correspondingly. In an embodiment, an importance score may be calculated for a business relationship. Importance scores for business relationships may be calculated based on interactions between two users, such as shared work-related projects, shared colleagues, number and/or frequency of business interactions, departmental chart, organization tree, and the like.

In an embodiment, the system may provide a relationship history that tells a story between two users, such as in a time line including locations, media, such as pictures, videos, or communication, phone call, email, or text message, that may tell a relationship story between two users. As such, as user may have a comprehensive view of the business and/or personal relationship.

In an embodiment, the system may suggest opportunities for further interactions between two uses based on their past interactions or relationship and/or their calendar or schedule. For example, based on the user's travel schedule, the system may determine that the user will be visiting a city and that another user who has a high importance score also is visiting the same city. The system may then suggest that they should meet up during their visit to the same city. Thus, the system may suggest opportunities for users to connect. In another example, the system may notify or remind a user to follow up with another user if they have not had the opportunity to interact for a while.

In an embodiment, the system may allow users to keep track of other people's preferences, such as dietary restrictions, favorite sports, and the like. The system may suggest further interactions between users based on the different user preferences. In an embodiment, the system may search and determine incentives or coupons applicable to the user's interaction with others. For example, the system may search for coupons to restaurants and may suggest the coupons to the user along with suggest for a dinner appointment with another user.

In an embodiment, the system may determine or allow a user to designate other users who are not favored by the user. As such, the system may determine and/or suggest routes, detours, schedules, calendars, or the like that may prevent the user from interacting with the disfavored users. For example, if a disfavored user is visiting a city at a certain date, the system may suggest alternate dates for the user to visit the same city to avoid running into the disfavored user.

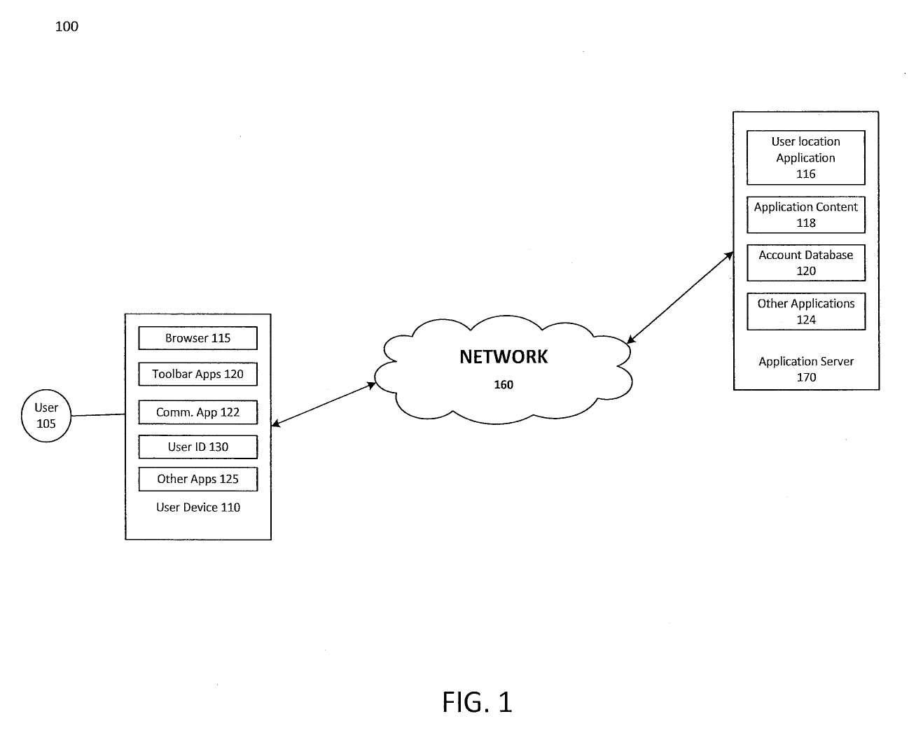

FIG. 1 is a block diagram of a networked system 100 configured to implement a process for managing contact information in accordance with an embodiment of the invention. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include communication devices, such as a user device 110 and an application server 170, in communication over a network 160. Application server 170 may be maintained by a merchant or a software company that develops and/or offers various applications for consumer electronic devices. A user 105, such as a consumer, may utilize user device 110 to download and install applications offered at the application server 170. For example, user 105 may utilize user device 110 to connect to the application server 170 to manage contact information. Although only one application server is shown, a plurality of application servers may be utilized.

User device 110 and application server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, wearable device, laptop computer, and/or other types of computing devices capable of transmitting and/or receiving data, such as Apple Watch, an iPad™ or an iPhone™ from Apple™.

User device 110 may include a communication module including hardware and applications for facilitating communications between user device 110 and other communication devices. The communication module may include hardware, such as CPU processor, WiFi card, Bluetooth Module, Ethernet card, and the like, for various wired and wireless communications including communication via LAN, WLAN, PTSN, LTE, 4G, or 3G network, and/or various other wired or wireless networks, including telecommunications, mobile, and cellular phone networks. User device 110 also may include a social interaction monitoring module including a CPU processor, applications, the communication module, location detection device, and/or various sensors for monitoring user 105 activities at user device 110 and identifying social interactions conducted by user 105. User device 110 may include a relationship module including the CPU processor, applications, and memory storing relationship database for inferring context and relationship between user 105 and other users. In addition, user device 110 may include a natural language processing module including the CPU processor and applications for processing and analyzing text-based communications to extract context and relationship from the communications.

User device 110 also may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115. User device 110 also may include other applications to perform functions, such as email, texting, voice and IM applications that allow user 105 to send and receive emails, calls, and texts through network 160, as well as applications that enable the user to communicate, transfer information, or make transactions.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used to associate user 105 with a particular application account at the application server 170. A communications application 122, with associated interfaces, enables user device 110 to communicate within system 100.

User device 110 may include a location detection device and applications for collecting location data, such as geo-location data via Global Positioning System (GPS), in-door location via Bluetooth Low Energy (BLE) and/or Near-Field Communication (NFC). User device 110 also may include various sensors for detecting temperature data, altitude data, humidity data, data regarding device movement, ambient sound data, imaging data via a camera, and etc. Further, geo-fencing or wireless beacon technology may be used to define a location. User device 110 may detect signals from devices that implement geo-fencing or wireless beacon technology. These environmental data may be utilized to determine a location or environment in which user device 110 is located.

Application server 170 may be maintained, for example, by a merchant or a software company which may provide applications or software contents that may be installed at consumer's computing devices to provide contact information management functionalities at the computing devices. Application server 170 may also include an account database 120 that includes account information for users having an account on application server 170, such as user 105. Account information may include contact information of users, such as name, address, phone number, email address, and the like. Account information may include relationship information between a particular user with respect to other related users. Application server 170 may collect and store various contact information of users. Application server 170 also may include a database that keeps track of contact information and relationship among different users.

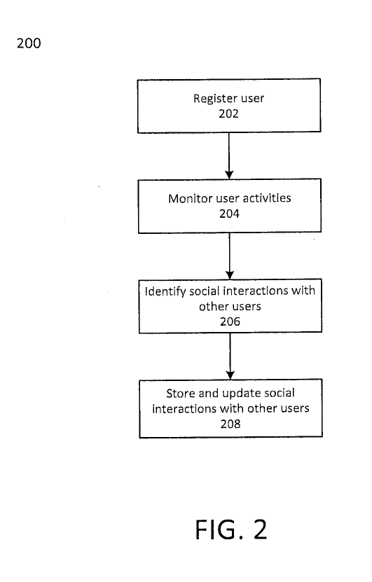

FIG. 2 is a flowchart showing a process 200 for setting up a user account for contact information management according to an embodiment. At step 202, a user may register at application server 170. For example, a user may set up a contact information management account at application server 170 using user device 140. The account may be used for storing and managing contact information. In an embodiment, the contact information may be stored and managed at user device 140 and be accessible by application server 170. The contact information may include user and/or other users' contact information, such as first, middle, last name, nick name, organization/company, address, phone numbers (mobile, home, business), fax number, email address, social network accounts, messaging ID, picture, birth date, web site, and the other user related information. The user 105 may enter or upload the contact information to the contact information management account.

At step 204, application server 170 and/or user device 140 may monitor user activities. In particular, user device 140 may include various types of sensors that may detect user activities, such as the user's location, movements, traveling paths, gestures, and other environmental information, such as temperature, altitude, ambient noise, voice, ambient lighting, and the like. For example, user device 140 may include a location detection device, such as a GPS device configured to receive signals from GPS satellites to detect the location of user device 140. In another example, user device 140 may include a Bluetooth communication device configured to detect and receive signals from a Bluetooth beacons installed at particular locations. As such, the location of user device 140 may be determined based on detecting the Bluetooth beacons. In particular, a location may be installed with a grid of Bluetooth beacons and the location of user device 140 may be determined from Bluetooth signals received from respective Bluetooth beacons in the location by triangulation. In still another example, user device 140 may include a NFC device configured to detect other NFC devices located nearby. As such, when another user is located near user 105, the NFC device of user device 140 may detect the NFC device of another user's device. This may allow the system to detect that user 105 is meeting with another user in person.

Further, user device 140 may monitor user 105's operation on user device 140, such as the user's operations to search or browse various products or services, the user's operations to communicate electronically with others, such as emails, text messages, and the like. User device 110 also may monitor user 105's operations of various applications, such as communication applications, e.g. telephone, email, or messaging applications, payment applications, shopping application, social networking applications, contact information applications, appointment or scheduling applications, and the like. User device 110 may monitor information entered or input by user 105 and information requested by user 105. In an embodiment, user device 140 may detect and monitor nearby devices of other users via Bluetooth Low Energy (BLE) or other Near Field Communication (NFC) channels. For example, user device 140 may be a wearable device, such as a smart watch. When user 105 is running in a park and a friend of user 105 also is running nearby in the park. The system may detect via user 105's smart watch and the friend's mobile device that they are both running in the park and have the same running path. Thus, the system may coordinate social interactions between user 105 and the friend, such as taking a break together later at a coffee shop.

At step 206, application server 170 and/or user device 140 may identify social interactions with other users from the monitored user activities. Social interactions may include email messages, text messages, phone calls, social related appointments, meeting appointments, in-person meetings, telephone conferences, video conferences, and any other social related interactions between user 105 and others. The social interactions also may include interactions of users on social networking sites or apps, such as FACEBOOK, INSTAGRAM, VINE, TWITTER, VIDDY, PINTEREST, and any social networking services. The social interactions may be identified by the type of user activities. For example, sending an email or making a phone call are social related types of activities and may typically be identified as social interactions between user 105 and others. User activities, such as setting an appointment on a calendar, scheduling a meeting, travel or location of user 105 relative to other users, also may be used to identify social interactions between user 105 and others. In an embodiment, the system may inquire user 105 whether a certain activity is related to a social interaction. For example, if the system detects that user 105 is moving to and is located near a particular user, the system may ask: “are you meeting with A?” Based on user 105's answer, the system may determine whether user 105 is having a social interaction with A. In still another embodiment, the system may allow user 105 to record or enter a social interaction. For example, after user 105 has a phone conversation with B, user 105 may enter and record that user 105 and B had a phone conversation to discuss certain topic.

In an embodiment, the system may identify a social interaction based on context. For example, user 105 may have an appointment on user 105's calendar to meet a friend at a certain time in a certain location. At the certain time, user device 140 may detect that user 105 is in the certain location and a device of the friend is also at the certain location near user 105. Thus, the system may infer, based on context information, that user 105 is meeting the friend at the certain location now. Each social interaction may include information, such as parties of social interaction, time, date, and locations, type of interaction, such as chance meeting, company outing, personal date, and the like, topic or context of interaction, such as purpose or topic, and other notes.

At step 208, application server 170 and/or user device 140 may store and update social interactions between user 105 and others. In particular, social interactions between user 105 and a particular user may be grouped together and associated with the contact information of the particular user in user 105's contact list or contact information. For example, the system may analyze phone numbers of telephone calls, email addresses of email messages, messaging ID of messages, and the like to identify the parties of social interaction and may associate the social interaction to the contact information of the parties.

For text-based social interactions, the system may analyze the text-based communication using natural language processing to provide context to the social interaction. Additional information about other users may be gathered from social interactions. For example, various preferences, such as food preferences, travel preferences, meeting place preferences, and the like, may be collected from the communication. Natural language processing may allow the various preferences to be organized in a contextual manner. For example, food preferences may be organized with grocery or restaurant preferences while travel preferences may be organized with flights, hotels, or location preferences. In an embodiment, the social interactions may be time stamped and may be organized in a chronological manner. As such, the system may construct a relationship story between user 105 and another user. The social interactions also may be organized by the types of interactions, frequency of interactions, most recent interactions, and the like. The system may continuously identify and update social interactions between user 105 and others.

By using the above process 200, various social interactions of user 105 may be identified and collected to provide context and relationship profiles between user 105 and others. In particular, the system may monitor user 105's activities and may identify social interactions between user 105 and others. Information about these social interactions may be associated and stored with the respective contact information of other users. Information about the social interactions may be used to generate a relationship profile or story between user 105 and other users. Information about the social interactions also may be used to infer or suggest opportunities to build relationships.

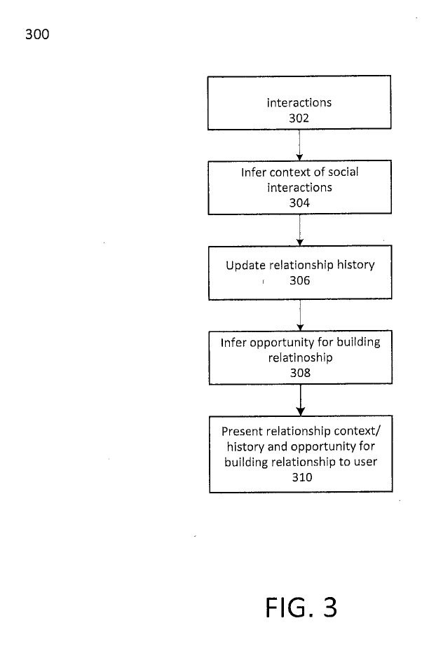

FIG. 3 is a flowchart showing a process 300 for implementing management of contact information according to one embodiment. At step 302, application server 170 or user device 110 may analyze a user's social interactions. In particular, the system may analyze the content of the social interaction, time, date, duration, location of the social interaction, type of social interaction, parties involved in the social interaction, duration and/or frequency of social interactions, and other information that may provide context to the social interactions. For example, if the social interaction is an email message, the system may analyze the message by natural language processing to determine the senders and receivers, topic and/or purpose of the message, and the like. If the social interaction is an in-person meeting, the system may analyze the location, duration, time, and date of the meeting. If the meeting is at a restaurant location, the meeting may be longer and may indicate an intentional and/or purposeful meeting. If the meeting is on a street and brief, the meeting may be a chance meeting. If the meeting is at a commercial office building, the meeting may be a business-related meeting. If the meeting is at a casual food court, the meeting may be personal-related.

In an embodiment, the system may also analyze video and/or audio communications, such as video messages, gif, or SNAPCHAT audio messages, FACETIME, SKYPE, FACEBOOK messenger, and the like. The messages may be analyzed using voice recognition or image recognition techniques with natural language processing to extract context or meaning related to relationships among users. For example, a user may leave a snapchat saying “it's great shopping shoes with you” to another user. This communication may be analyzed, and the system may record the affiliation of buying shoes or shopping with the another user. In still another embodiment, the system may analyze communications including handwritten inputs. The handwritten inputs may be analyzed by character recognition techniques to recognize symbols, numbers, and characters. Thus, the system may extract context and relationship from the handwritten communications. For example, a user may snap a picture of the user's handwritten notes and send them to another user. The system may recognize that the handwritten notes contain context information related to another user. Thus, the system may capture this context information and update the relationship history.

At step 304, the system may infer the context of social interactions. In particular, the system may analyze external information that may provide context to the social interactions. For example, external information, such as contact information of other users, social networks, company organization charts, family trees, social network accounts, official records, news events, environmental factors detected by user device 110, user 105's calendar and/or schedule, user 105's preferences, routines, and habits, and other external information may be used to infer the context of social interactions. For example, based on social network accounts and previous communication history and routines, the system may determine that an email is a social interaction between two friends. In another example, based on a company organization chart and the business phone number, the system may determine that a telephone call is between a manager and an employee at a company. As such, various information extracted from a social interaction, such as a phone call, an email, an in-person meeting, may be analyzed in view of the surrounding external information to provide context to the social interaction.

At step 306, the system may update relationship history. In particular, based on the parties involved in the social interaction, the system may update the relationship history associated with the contact information of the party. For example, if user 105 had a meeting with user A, the information about this social interaction may be recorded and associated with the contact information of user A at user 105's contact list. If multiple users are involved in a social interaction, the information of the social interaction may be updated to the contact information of each of the parties involved in the social interaction.

In an embodiment, social interactions that are relevant to previous social interactions may be associated or grouped together. For example, discussions about planning a vacation that continues through different communication channels, such as through emails, text messages, and phone calls, may be associated with each other to provide the users with a continuous stream showing the progress of the discussion and where the discussion last left off. As such, the parties of the discussion may quickly pick up where the discussion last left off and continue the discussion via different communication channels.

In an example, user 105 has been emailing and texting user C about going to a movie. User 105 and user C communicated the discussion through text messages, emails, and social network accounts. The system may analyze these different social interactions and may determine that these social interactions between user 105 and user C have similar themes and topics related to going to a movie tonight. As such, the system may group these social interactions together and associate them with contact information of user C. As such, when user 105 is communicating with user C again, the string of previous social interactions may be provided or displayed to user 105 to provide context and to help user 105 continue their discussion about going to the movie tonight. In another example, when user 105 meets up with user C in person, the system may provide information regarding previous social interactions between user 105 and user C to provide context and to help user 105 and user C continue their discussion. In an embodiment, the discussion between user 105 and C may include another person D, as such, the system may include D in the follow up discussion or communication, unless there are indications during the previous communication that D should not be included (e.g., D decided not to go to the movie).

At step 308, the system may infer opportunities for building relationships. In particular, based on user 105's previous social interactions, relationship preferences, calendars, schedules, location, travel route, and/or other user defined criteria, the system may infer opportunities for user 105 to interact with particular people. In an embodiment, the system may calculate an importance score for each person on user 105's contact list. The importance score may depend on degree of relationship, family tree, organization chart, frequency, duration, and types of social interactions with the person, user 105's preference for social interactions, user defined interest to connect with certain people, and the like. In an embodiment, the importance score may be calculated based on family relationship, friendship, and/or professional relationship. For example, importance score for close family relatives may be higher than distant family relatives. In another example, close friends may have higher importance score than acquaintances. In still another example, people who frequently do business with user 105 may be assigned with higher importance scores.

For example, based on user 105's business or professional profile, the system may infer that user 105 may wish to connect with people with similar business or professional profiles. In another example, user 105 may designate certain people that user 105 wishes to connect once a week or periodically. The system may automatically check user 105's calendar or schedule and the calendar and/or schedule of the person user 105 is interested in connecting, their respective locations, their respective preferred type of social interaction and may suggest opportunities for them to connect when they are both available and types of social interactions that both preferred.

In an embodiment, the system may analyze user 105's travel schedule and/or travel itinerary and may suggest contacts who are located at user 105's destination. The system may automatically access and analyze user 105's calendar and schedule and may find available time for user 105 to meet with the person located at user 105's destination. In an embodiment, the system may keep track of user 105's social interactions and may suggest opportunities for user 105 to follow up on user 105's previous social interactions. For example, user 105 may bump into a friend on a street and may wish to catch up later with the friend. The system may detect the chance meeting on the street and may find and suggest opportunities for user 105 to meet up with the friend.

At step 310, the system may present relationship history and/or opportunity for building relationships to user 105. In an embodiment, when user 105 accesses the contact list at user device 110, the user device 110 may provide options for user 105 to review social interaction history between user 105 and the selected contact. In an embodiment, the system may present user 105 with a list of social interactions that occurred between user 105 and the selected contact. The list may be presented in chronological order or in reverse chronological order with the most recent social interaction presented first on the list. In another embodiment, the list may be presented by types of communications, importance, and/or any other order as desired by the user. As such, user 105 may review a history of social interactions between user 105 and the selected contact. Information included in the list of social interactions may include the location, time, date, type of social interaction, topic/purpose of social interaction, other parties involved, importance, notes, and the like. The social interactions may include all types of interactions, such as emails, messages, in-person meeting, chance meeting, get-togethers, work-related meetings, phone calls, video conferences, and the like. The system may aggregate and list all types of social interactions between user 105 and the selected contact to provide context and relationship history to user 105.

In an embodiment, the system may allow user 105 to request future opportunity for connecting. The system may analyze past social interactions between user 105 and the selected contact to determine the context, relationship type, availability, and preferences of both user 105 and the selected contact and may suggest an opportunity for user 105 and the selected contact to connect. For example, user 105 may wish to connect with user A. The system may analyze previous social interactions between user 105 and user A and may determine that user 105 and user A have professional relationship based on previous business dealings. The system may check the location, calendar, schedule of both user A and user 105 and may find opportunities that are mutually preferred by both user A and user 105 at a location and time and date when user A and user 105 are both available. In an embodiment, the professional relationship between user 105 and A may include another person B. As such, the system may include B in future communications or meetings between user 105 and A.

In an embodiment, the system may filter and select advertisements and/or incentives that are applicable to the suggested opportunity for user 105 and the selected contact to connect. For example, meal coupons at a restaurant, discounts at coffee shops, group discounts for a group trip, and other incentives that are applicable for user 105 and the selected contact to use for their connecting opportunity may be suggested to user 105. As such, user 105 may have additional incentives to connect with the selected contact.

In an embodiment, the system may allow user 105 to designate certain contacts in the contact list as favorites, such as user 105's close friends or immediate family members. The system may provide comprehensive relationship history for these favorite contacts and may suggest more opportunities for user 105 to interact with these favorite contacts. For example, if user 105 has not met up with a close friend for more than a week, the system may automatically find and suggest an opportunity for them to meet up based on both of the friend and user 105's calendar, schedule, and preferences for social interactions. In another example, user 105 may designate certain contacts as important people for professional or business purposes. As such, the system may keep track of various social and/or business interactions between user 105 and the important people. Further, the system may find opportunities for user 105 to interact with the important people in professional and/or business context. For example, user 105 may designate the CEO of a company where user 105 is working as an important person in a professional context. The system may find opportunities for user 105 to meet with the CEO. For example, the system may detect that the CEO is visiting the office building where user 105 is working. As such, the system may notify user 105 and may suggest opportunities for user 105 to introduce himself to the CEO.

In an embodiment, the system may allow user 105 to designate certain disfavored contacts in the contact list that the user 105 would prefer to avoid. As such, the system may suggest routes or schedules that may help user 105 avoid running into the disfavored contacts. For example, user 105 may designate user 105's supervisor at work as a disfavored person for non-business hours. The system may suggest locations or detours that may help user 105 avoid running into the supervisor after work or during weekends. The system may also notify user 105 if the supervisor is detected near user 105 to warn user 105.

By using the above processes 200 and 300, the system may analyze the user's social interactions to provide relationship history and context to people in user's contact list. In particular, the system may capture and analyze social interactions between the user and others from various communication channels and may associate them with the relevant contacts in user's contact list. The social interactions may be grouped by particular topics or purposes to provide context to the user. The system also may infer and suggest opportunity for the user to connect with others based on previous social interactions. Further, the system may provide incentives applicable to the inferred connection opportunity to the user.

The above processes 200 and 300 may be implemented at the user device 110. In an embodiment, the above processes 200 and 300 may be implemented at the application server 170. In still another embodiment, the above processes 200 and 300 may be implemented by the user device 110 and the application server 170 in coordination with each other. Note that the various steps described herein may be performed in a different order, combined, and/or omitted as desired.

The following are exemplary scenarios in which the above system and methods may be implemented.

A User is shopping at a shopping center and runs into a friend. The user's mobile phone detects via GPS and/or NFC that user is located near the friend. The user previously had a quick conversation with the friend and indicated that they should meet up some time next week to catch up. After the chance meeting at the shopping center, the user's mobile device records this social interaction and asks the user whether the user would like to follow up with the friend. The user agrees and the system begins to analyze and compare the user's and the friend's calendar, schedule, locations, and meeting preferences based on previous social interactions. The system suggests that they should meet next Tuesday for lunch at a restaurant near the friend's work place. The system also finds coupons for discounts for lunch for two at the restaurant. The user agrees to this suggestion and the system automatically sends a message to the friend inviting the friend to this lunch next week.

The user continues to shop at the shopping center. The system detects that based on the user's contact list and the user's family tree, the user's cousin happens to be visiting the city and is now also shopping at the shopping center. The system informs the user and asks user whether the user would like to meet up with the cousin at the shopping center. Based on the availability of the user and the cousin according to their respective schedules and preferences and the current time of the day, the system may suggest a coffee shop or a restaurant for them to meet and also coupons they can use for the coffee shop or restaurant.

The user is scheduled for a doctor's appointment at 5:00 PM. However, the system detects the user's location and movement and determines that the user is likely to be late and estimate the new arrival time based on current traffic conditions and the user's location and travel progress. The system may automatically notify the doctor's office that user is likely to be late and provide the doctor's office with the estimated new arrival time.

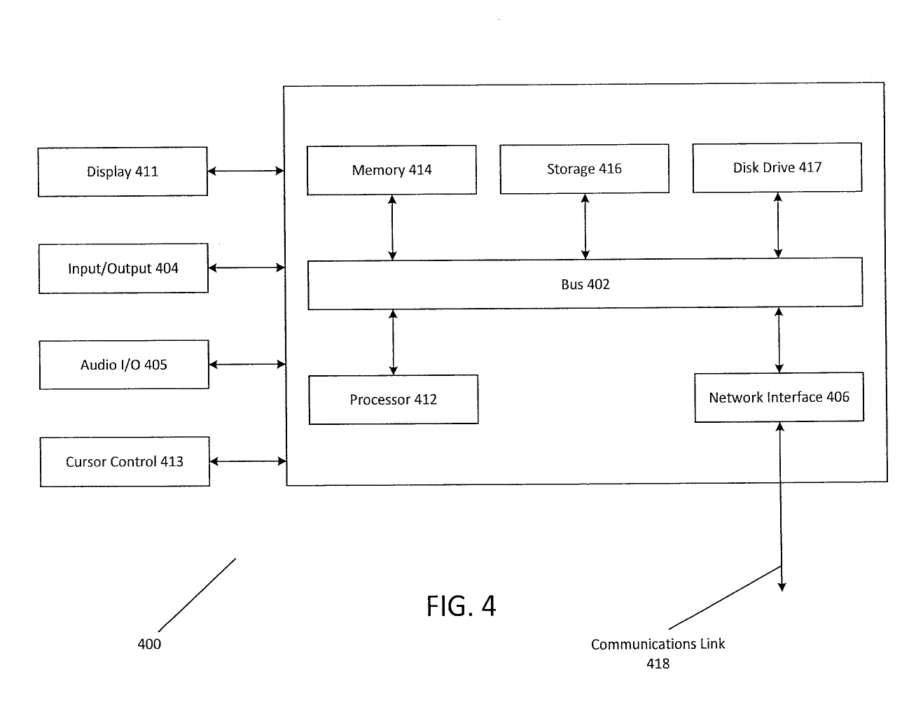

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, wearable device, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A communication device comprising:
a hardware memory storing an account of a user including a contact list of individuals related to the user;
a communication module configured to facilitate communications between the user and one or more individuals on the contact list;
a social interaction monitoring module configured to monitor communications between the user and one or more individuals on the contact list; and
a relationship module configured to determine context and relationship between the user and the respective individuals on the contact list based on the communications between the user and one or more individuals on the contact list.

2. The communication device of claim 1 further comprising:
a location detection device configured to detect a location and movement of the user with respect to locations and movements of the one or more individuals on the contact list, wherein the social interaction monitoring module is configured to determine social interactions between the user and the one or more individuals on the contact list based on their relative locations and movements.

3. The communication device of claim 2, wherein the location detection device is one or more of a Global Positioning System (GPS), a Bluetooth Low Energy (BLE) device, and a Near-field Communication (NFC) device.

4. The communication device of claim 1 further comprising a display device configured to display the contact list to the user, wherein the relationship module is configured to formulate information of social interactions between the user and the one or more individuals to be displayed with the contact list.

5. The communication device of claim 4, wherein the relationship module is configured to associate each social interaction to one or more relevant individuals on the contact list and to formulate the information of social interactions to be displayed along with the contact information of the one or more relevant individuals on the contact list.

6. The communication device of claim 5, wherein the social interactions are displayed in a chronological order as a history of social interactions.

7. The communication device of claim 5, wherein the social interactions are displayed in a reverse chronological order with a most recent social interaction displayed first.

8. The communication device of claim 1 further comprising a natural language processing module configured to determine the context and the relationship from the communications by natural language processing.

9. The communication device of claim 1, wherein the relationship module is configured to:
receive user selection of favored individuals from the contact list; and
infer opportunity for the user to connect with the favored individuals from the contact list.

10. The communication device of claim 1, wherein the relationship module is configured to:
receive user selection of disfavored individuals from the contact list; and
provide suggestions for the user to avoid the disfavored individuals.

11. The communication device of claim 9, wherein the relationship module is configured to:
search for incentives applicable to the opportunity for connection; and
present the incentives to the user along with the opportunity for connection.

12. A system comprising:
a hardware memory storing an account of a user including a contact list of individuals related to the user;
a communication module adapted to receive information of social interactions conducted by the user and detected via a user device of the user; and
one or more hardware processors adapted to:
link the social interactions with respective individuals listed in the contact list stored in the hardware memory; and
determine context and relationship between the user and the respective individuals in the contact list based on the social interactions.

13. The system of claim 12,
wherein the communication module is further adapted to receive locations and movements of the user detected by a location detecting device included at the user device, and
wherein the one or more processors are further adapted to:
compare the locations and movements of the user with respect to locations and movements of individuals on the contact list;
determine social interactions between the user and one or more of the individuals based on the comparison.

14. The system of claim 12,
wherein the communication module is further adapted to receive communication information of communications conducted via the user device between the user and one or more of the individuals listed in the contact list; and
wherein the one or more processors are further adapted to:
process the communication information by natural language processing; and
determine the context and the relationship between the user and the one or more individuals based on the communication information.

15. The system of claim 12, wherein the communication information includes one or more of an email, a text message, a telephone call, a video conference, a social network posting, a web posting, and a location check-in.

16. The system of claim 12, wherein the one or more processors are further adapted to:
analyze social interactions between the user and one or more individuals on the contact list; and
generate a relationship history for each of the one or more individuals on the contact list.

17. The system of claim 12, wherein the one or more processors are further adapted to:
analyze social interactions between the user and a particular individual on the contact list; and
infer an opportunity for the user and the particular individual to connect based on the social interactions.

18. The system of claim 17, wherein the one or more processors are further adapted to:
determine availability of the user and the particular individual based on their respective calendars; and
infer the opportunity for the user and the particular user to connect based on a time and a date when both the user and the particular individual are available.

19. The system of claim 17, wherein the one or more processors are further adapted to:
determine social interaction preferences of the user and the particular individual based on their previous social interactions; and
infer the opportunity for the user and the particular individual to connect based on both of the user's and the particular individual's preferences.

20. A system for managing social interactions between a user and one or more individuals listed on a contact list of the user, the system comprising:
means for receiving information of social interactions conducted by the user and detected via a user device of the user;
means for linking the social interactions with respective individuals listed in the contact list; and
means for inferring context and relationship between the user and the respective individuals in the contact list based on the social interactions.

21. The system for managing social interactions of claim 20, wherein the system further comprising means for inferring an opportunity for the user to connect with one or more individuals listed in the contact list based on the social interactions.
